(19) United States
(12) Patent Application Publication
(10) Pub. No.: US 2009/0144249 A1
(43) Pub. Date: Jun. 4, 2009

(54) METHOD AND SYSTEM FOR RETRIEVING INFORMATION BASED ON MEANINGFUL CORE WORD

(75) Inventor: Il-Hyung Jung, Seoul (KR)

Correspondence Address: KNOBBE MARTENS OLSON & BEAR LLP, 2040 MAIN STREET, FOURTEENTH FLOOR, IRVINE, CA, 92614, US

(73) Assignee: KT CORPORATION, SEONGNAM-CITY (KR)

(21) Appl. No.: 12/364,389

(22) Filed: Feb. 2, 2009

Related U.S. Application Data
(63) Continuation of application No. 10/257,847, filed on May 6, 2003.

(30) Foreign Application Priority Data
Apr. 18, 2000 (KR) 10-2000-0020398

(51) Int. Cl. G06F 17/30

(52) U.S. Cl. 707/3; 707/E17.108

(57) ABSTRACT

The present invention relates to a method and system for extracting a meaningful core word from a query and a method and system for retrieving information based on the same are disclosed. The system for retrieving extracts a meaningful core word of a lemma, expands the lemma and retrieves texts based on the expanded lemma, to thereby improve performance of the retrieval system and convenience of a user.

### TECHNICAL FIELD

The present invention relates to a method and system for extracting meaningful core words and retrieving information based on the meaningful core word; and, more particularly, to a method and system for extracting a core word, a stem word or a derivative, from a lemma, and to an information retrieval system whose performance is improved and convenient with the core word extracting method, and to a computer-readable recording medium for recording the method and a program for embodying the methods as well as a computer-readable recording medium for recording data of the core word dictionary.

### BACKGROUND ART

As commonly known, the technique called information searching has started in response to the need for searching information quickly, precisely and easily. Developed to meet the need, an information retrieval system provides a user with information most proper to his or her need. As the amount of information increases, the information retrieval system does not find out information directly in each datum but adopts an index system in which data are processed and stored in advance in easy forms for data searching so that information can be searched in real-time. As seen above, information searching is conducted in three steps: querying, indexing and searching. At the indexing step, data are collected in advance and processed into easier search and then stored. At the querying step a user requires information, and at the searching step, information corresponding to his or her query is provided.

The information searching can be served in various forms. For instance, there can be cases where a computer operating system searches a certain file or folder from the data of a hard disk or an auxiliary memory unit, where a certain word or a string of a word is searched for in a piece of document of a word processor, where a certain word is searched for in an electronic dictionary of an electronic scheduler or in an electronic dictionary, which is an off-line application software, and where an on-line server program of electronic dictionary searches and provides information related to a certain word requested by a client computer.

Nowadays, the capacity of computer-related storage medium is growing bigger, and the propagation of the Internet connects computers all around the globe into one great network, thus the amount of information rising in geometric progress. Therefore, it gets to be hard to find out the exact information in need quickly and easily from the immense amount of information.

The performance of searching is measured by two factors. One is the ratio of reappearance and the other the ratio of accuracy. The ratio of reappearance is the ratio of the appropriate texts searched to the appropriate texts the system has. The ratio of accuracy means the appropriate ratio texts to the texts searched out. That is, the ratio of reappearance indicates the ability of a system searching for the appropriate texts, while the accuracy ratio shows the ability of a system not searching for inappropriate texts. To put it in other way, the former measures the completeness of the search, while the latter measures the accuracy of the search.

Therefore, the most perfect retrieval system would have 100 percent of reappearance and accuracy ratios. But, normally, the two ratios are in inverse proportion. In other words, when expanding the search range to get a high reappearance ratio, the accuracy ratio drops, and when shortening the search range to heighten up the accuracy ratio, the ratio of reappearance drops. It's rare to have both ratios high actually. So, for every retrieval system, people are trying to improve the two factors at the same time.

However, along with the introduction of the Internet, the information amount gets huge, and thus it becomes hard to measure the reappearance and accuracy ratios. When the amount of object texts to be searched increases as in the Internet, the search results come out a lot and thus it becomes hard to figure out how many appropriate texts are searched among the total objects texts for searching. That is, even if appropriate texts for a query are searched out, it's impossible to figure out the number of texts not searched, and it's quite hard and burdensome for a user to check every single text and see if it's appropriate or not among all the data searched out. The quality of searching is closely related to the efficiency of indexes. Indexing means extracting and storing index words in advance, the information needed for text data to be searched. It is needed for efficient information searching. The information retrieval system compares a user's query with the index and provides the most suitable information.

As for the method for generating indexes, there are a manual method performed by one skilled in the art and an automated index generation method performed by a computer program. Manual indexing requires more labor and time compared to the automated indexing. So it's hard to use it on the numerous texts of the Internet actually. Moreover, even the same indexer may select different index words in the same situation at different try. So, it's hard to keep consistency, generating disagreement between the indexer and the user searching information. The automated indexing is conducted by a computer. So, not only it's possible to index a great deal of texts very fast, but also it can keep consistency, too, according to the automated index program a system adopts. Despite the advantages of this automated indexing, the disagreement still exists between the query words by a user and an index words selected by the indexer jut as manual indexing. The data generator's selection of varied expressions of one terminology causes the disagreement of index words because the index words are selected from the text by an indexing program. Studies have been done to solve this problem and to draw out the same searching result for the same query words from a user.

In the meantime, the efficiency of an index is determined by two factors, i.e., thoroughness and particularity. The particularity of an index means the ability of the index expressing a certain concept exactly. The higher the particularity of an index is, the more efficiently appropriate texts are searched because it's possible to express a concept more particularly. The thoroughness of an index means how many index words are used to express the concept a text deals with. Because all the peripheral concepts including the core concept of a text are selected as index words, the thoroughness gets higher. So, while the reappearance ratio goes up, the accuracy ratio goes down because the texts of peripheral concepts are searched. After all, the reappearance ratio depends on the thoroughness of the index and the accuracy ratio on the particularity.

Meanwhile, the method of searching is conducted in reverse of the indexing method. For instance, if there is a word “political” in a text and the word “politic” is indexed, the key word “politic” is generated from the query word “political” during the search and the text with the word is searched. If the word “political” is indexed, “political” is generated as a key word from the query word “political” during the search, and texts including the word is searched. If two word strings “politic” and “al” are indexed, “politic” and “al” are generated as key words from the query word “political” during the search and texts including both strings at the same time are searched. That is, indexing the word “political” and generating, “politic” as a key word makes the search fail.

On the Internet with the numerous data and web pages, there are scores of web search engines. Inputted with a query word by a user, they search and provide the location of web documents that may be most suitable for it. Here, the location means a directory or a path where web documents a user wants are gathered (directory search, web category search, or an Internet address, or URL, of a certain web document (web page search).

However, the present Internet retrieval systems actually search for and provide very little part of the information a user wants, thus dropping the confidence of information search. Sticking to the convenience of a user and searching speed, conventional search engines index data in a well-known simple way, comparing and determining index words with query words. So, a little difference in the expression for an object in indexing and interpreting a query may rule out information out of the search objects for comparing with the query word. That is, retrieval systems remain in low efficiency because unilateral expressions by an information producer, indexing expression by an indexer and the query expression by an information user are all somewhat different to each other.

For one example, there may be a case where an information producer expresses certain information as “politician” and an indexer or indexing program indexes it “politic” and an information user inquires “politician.” Here, when the user searches information indexed with the query word “politician” in an information retrieval system, the information indexed with “politic” will be missed out. Also, when the information is indexed with “statesman” in the above case, texts with the query word “politician” are not searched. As shown here, there are terms with the same meaning and the same concept may be expressed differently. So, even if there is information in need actually, it fails to be provided because it is recognized as a different one. Therefore, the conventional retrieval systems which are embodied this way can provide information corresponding to the query word only after a user types in all the related words, i.e., “politic,” “politician,” “statesman” and “political,” to search information related to “politic.” This causes inconvenience in using and a shortcoming of falling down the confidence in information searching.

In the mean time, another example shows a case where an information producer expresses certain information as “backbone” and an indexer or an indexing program indexes it “back,” “bone” and “backbone,” and an information user inquires “back.” Here, when using an information retrieval system and searching information indexed with the user's query word “back,” information indexed with “back” will be provided as the search results. Of course, if a person who understands different concepts of words indexes the information manually, “backbone” will not be indexed as “back.” But when the data is automatically indexed by a computer program, or when an indexing method that may lead to the same result is chosen, the wrong searching results may be provided as shown above.

To avoid low searching efficiency resulting from different expressions in information production, indexing and querying, another indexing and searching methods are currently used in some high-quality information retrieval systems. These systems adopt various expressions of related terms, which will be described hereinafter.

Generally, the collected expressions include synonyms, words with the same meaning (politician vs. statesman), words with similar meaning but spelled differently (atmosphere vs. air, elderly vs. aged vs. retired vs. senior citizens vs. old people vs. golden-agers), same words that may be spelled differently (theatre vs. theater, color vs. colour), thesaurus, etc. Among them, the thesauruses, which cover most relations between words, include broad range of relations such as synonyms, similar words, broad words, terms for expanded meaning (atmosphere vs. environment), narrow words, terms for narrower meaning (atmosphere vs. oxygen) and other word relations.

However, when employing these thesauruses on a retrieval system, it's hard to do construction itself and the searching efficiency drops remarkably due to too many related words searched. Here is an example. When the query word is “credit card,” the word “card” gets expanded to “trump,” a similar word to card, which results in low accuracy ratio. So, even though a system adopts the thesauruses, it is limitedly used as a derivative function for searching data when there is no search result coming out or only a few special cases.

For another example, when a user inquires “air pollution” and the thesaurus are allowed as above, the word gets expanded to include a word with similar meaning “atmosphere”, a broader word “environment,” a narrow word “oxygen.” So the searching efficiency falls down dramatically by searching words, e.g., “atmosphere pollution,” “environment pollution,” and “oxygen pollution.” Also, as seen above, in case of a system indexing “big business” with “big,” the expansion of thesaurus enlarges the wrong search results and deteriorates the quality of the retrieval system.

Meanwhile, in constructing thesauruses, selection of terms and relating them to each other as well as the kind of relations to be used in information searching and control of the levels influence the quality of the information retrieval system employing thesauruses, which makes it hard to construct an information retrieval system, and increases the system construction cost and system load.

Examples of the conventional searching method adopted in the existing systems will be described in detail hereinafter.

As for a simple string matching method in which linguistic knowledge is not used and natural language is not considered, there are two methods.

First, in case a user inquires “superhigh-speed internet,” among the conventional methods, the search engines, which search for what is wholly matched, find out web documents that include “superhigh-speed” and “internet.” Although the query word “superhigh-speed” is seemingly different from “high-speed,” it's obvious that what is demanded from “superhigh-speed” is the same as that from “high-speed internet.” However, this type of information retrieval systems have a problem of ruling out information by failing to find out web documents that include “high-speed,” the key word of “superhigh-speed,” and “internet.”

Secondly, in case a user inquires the word “back,” among the search engines, which allow partial matching, have a problem of finding out all the web documents with words having the string of “back,” such as “backbone.” Unlike the above, there are other search engines that employ linguistic knowledge, e.g., synonyms, words with similar meaning, the same words spelled differently and thesauruses, and thus process natural languages. In case of using a common dictionary, linguistic process such as morpheme analysis is conducted. Since the word “backbone” is listed as a lemma, however, the engine recognizes it as a query word but does not conduct searching for its stem word “bone.” That is, when using the conventional search engine and inquiring “backbone,” documents which do not use “backbone” but use “bone” or “back” are excluded, leading to considerable information loss and dropping confidence of the searching. Also, in case of using special dictionary such as synonym dictionary or adopting linguistic knowledge like thesauruses, there is an adverse effect of dropping accuracy ratio in the process of increasing the reappearance ratio.

### DISCLOSURE OF INVENTION

It is, therefore, an object of the present invention to provide an information retrieval system, a method thereof, and a computer-readable recording medium for recording a program embodying the method by extracting a word, stem word or derivative, having core meaning of a lemma based on a core word dictionary, expanding the lemma, and then conducting search by a key word, thus improving the performance of a system and being more convenient for a user.

It is another object of the present invention to provide information search results in order most suitable for a query, by extracting a word, stem word or derivative, having core meaning of a lemma based on a core word dictionary, expanding the lemma, and then conducting information search with a key word, thus improving the performance of a system and being more convenient for a user.

It is still another object of the present invention to provide a method of extracting a word, stem word or derivative, having core meaning of a lemma based on a core word dictionary and a computer-readable recording medium for recording a program embodying the method.

It is still another object of the present invention to provide a computer-readable recording medium for recording data of a core word dictionary that includes lemmas and identifiers for identifying the kinds of the lemmas and words, stem words or derivatives, having core meaning of the lemmas.

It is still another object of the present invention to provide a computer-readable recording medium for connecting and recording a first and a second core dictionaries, the first core word dictionary including lemmas of stem words and derivatives having core meaning of the lemmas and the second core word dictionary including lemmas of derivatives and stem words having core meaning of the lemmas.

It is another object of the present invention to provide a computer-readable recording medium for recording data of a core word dictionary including lemmas and words having core meaning of the lemmas.

In accordance with one aspect of the present invention, there is provided an information retrieval system based on a core word dictionary, comprising: a core word dictionary storage unit for storing information to find out words having core meaning of lemmas, i.e., core words; a matching unit for receiving a query from a user; an information search unit for searching related information with lemmas and core words as key words, the lemmas having being set one or more to be inquired to data stored in the core word dictionary according to the query received and the core words having being extracted by being inquired to the core word dictionary storage unit with the lemma set above; and an output unit for outputting results searched by the information search unit.

In accordance with one aspect of the present invention, there is provided an information retrieval system based on a core word dictionary, comprising: a core word dictionary storage unit for storing information to find out words having core meaning of lemmas; a matching unit for receiving from a user a query and selection information on whether to expand the query word or not based on the core word dictionary; an information search unit for searching related information with lemmas and core words as key words, the lemmas having being set one or more according to the query received and, after checking if the transmitted selection information is expanded one or not, if it isn't, searching being conducted with the set lemmas, otherwise, the core words having being extracted by being inquired to the core word dictionary storage unit with the lemmas set above; and an output unit for outputting results searched by the information search unit.

In accordance with one aspect of the present invention, there is provided a method of searching information applied to an information retrieval system based on a core word dictionary, the method comprising the steps of: a) constructing the core word dictionary to be able to find out words having core meaning of a lemma; b) setting one or more lemmas out of a query from a user to be inquired to the core word dictionary; c) expanding a lemma by extracting a core word of the lemma from the core word dictionary; d) searching for related information with the lemma set above and the extracted core word; and e) outputting the result of the information searching.

In accordance with one aspect of the present invention, there is provided a method of searching information applied to an information retrieval system based on a core word dictionary, the method comprising the steps of: a) constructing the core word dictionary to be able to find out words having core meaning of a lemma; b) receiving from a user a query and selection information on whether to expand the query word based on the core word dictionary; c) setting one or more lemmas out of the query from the user; d) checking if the selection information from the user is one expanded based on the core word dictionary; e) if it is not expanded selection information, conducting information searching with the set lemma and outputting the search result; and f) if it turns out to be expanded selection information, expanding the lemma by extracting a core word of the lemma from the core word dictionary, searching related information by taking the set lemma and the extracted core word as key words, and outputting the result. In accordance with one aspect of the present invention, there is provided a method for extracting a core word from a lemma applied to a core word extraction system out of a lemma based on a core word dictionary, the method comprising the steps of: a) constructing a core word dictionary to find out words having core meaning of a lemma; b) setting one or more lemmas out of a query from a user to inquire to the data of the core word dictionary; and c) inquiring the set lemma to the core word dictionary and extracting words having core meaning of the lemma.

In accordance with one aspect of the present invention, there is provided a method for extracting a core word from a lemma applied to a core word extraction system out of a lemma based on a core word dictionary, the method comprising the steps of: a) constructing a core word dictionary to find out words having core meaning of a lemma; b) receiving from a user a query and selection information on whether to expand the query based on the core word dictionary; c) setting one or more lemmas from the query; d) checking if the selection information from the user is one expanded based on the core word dictionary; e) if it is not expanded selection information, not expanding the lemma set above; and f) if it is expanded selection information, inquiring the set lemma to the core word dictionary and expanding the lemma by extracting words having core meaning of the lemma.

In accordance with one aspect of the present invention, there is provided a computer-readable recording medium for recording a program to embody the method of searching information based on a core word dictionary in an information retrieval system equipped with a processor, the method comprising the steps of: a) constructing a core word dictionary to find out words having core meaning of a lemma; b) setting one or more lemmas out of a query from a user to inquire to the data of the core word dictionary; and c) expanding the lemma by extracting a core word having core meaning of the lemma from the core word dictionary; d) using the set lemma and the extracted core word as key word and searching related information; and e) outputting the searched result.

In accordance with one aspect of the present invention, there is provided a computer-readable recording medium for recording a program to embody the method of searching information based on a core word dictionary in an information retrieval system equipped with a processor, the method comprising the steps of: a) constructing a core word dictionary to find out words having core meaning of a lemma; b) receiving from a user a query and selection information on whether to expand the query based on the core word dictionary; c) setting one or more lemmas out of the query from the user; d) checking if the selection information is one expanded based on the core word dictionary; e) if it is not expanded selection information, conducting information search with the set lemma and outputting the search result; and f) if it is expanded selection information, expanding the lemma by extracting a core word of the lemma, then using the extracted core word as a key word, searching related information and outputting the search result.

In accordance with one aspect of the present invention, there is provided a computer-readable recording medium for recording a program to embody the method of searching information based on a core word dictionary in an information retrieval system equipped with a processor, the method comprising the steps of: a) constructing a core word dictionary to find out words having core meaning of a lemma; b) setting one or more lemmas out of the query from the user to inquire to the data of the core word dictionary; and c) inquiring the set lemma to the core word dictionary and extracting words having core meaning of the lemma.

In accordance with one aspect of the present invention, there is provided a computer-readable recording medium for recording a program to embody the method of searching information based on a core word dictionary in an information retrieval system equipped with a processor, the method comprising the steps of: a) constructing a core word dictionary to find out words having core meaning of a lemma; b) receiving from a user a query and selection information on whether to expand the query based on the core word dictionary; c) setting one or more lemmas from the query; d) checking if the selection information from the user is one expanded based on the core word dictionary; e) if it is not expanded selection information, not expanding the lemma set above; and f) if it is expanded selection information, inquiring the set lemma to the core word dictionary and expanding the lemma by extracting words having core meaning of the lemma.

In accordance with one aspect of the present invention, there is provided a computer-readable recording medium for recording the data of: a lemma field for filling up a lemma, i.e., a stem word or a derivative; an identifier field for inserting an identifier identifying if the lemma in the lemma field is a stem word or a derivative; and a core word field for inserting a derivative having core meaning of the lemma if the lemma, the core word of the lemma, is a stem word, and if the lemma, the core word of the lemma, is a derivative, inserting a stem word having core meaning of the lemma.

In accordance with one aspect of the present invention, there is provided a computer-readable recording medium for recording the data of: a lemma field for inserting a lemma; a stem word field for filling up a stem word having core meaning of the lemma; and a derivative field for inserting a derivative having core meaning of the lemma. In accordance with one aspect of the present invention, there is provided a computer-readable recording medium for recording the data of: a lemma field for inserting a lemma; and a core word field for inserting a core word, i.e., a stem word or a derivative, having core meaning of the lemma.

Here, the stem word means a string composing a lemma word and it includes all or a part of the string, forming a core meaning of the lemma. The string should not necessarily continuative. The stem word “politic” constitutes the core meaning of the lemmas, “politician,” “political,” and “politics.”

And the “politician,” and “political” are derivatives having “politic” as a stem word. As you can see here, derivatives are words having core meaning of the corresponding lemmas. For instance, if a lemma is “politician,” its stem word should be “politic,” and its derivatives being “politician” and “political,” ruling out a word such as “policy.”

As another example, there is a word “cookbook,” which is composed of two words, “cook” and “book.” Both or either one of them can be its stem words. How to select stem words is wholly a matter of policy on how to construct a core word dictionary, considering the performance of an information retrieval system. Thinking over the interest of a user, it's common to select the stem word of “cookbook” as the word “cook.” Rather than to be information on “book” apart from “cook,” it is thought that a user would be interested in information related to “cook,” though it may not be related to “book.” A word like “laserprinter” is the same case, the word “printer” being the stem word here.

Yet another example is “ [symbol] (infant baby)” whose stem words are “ [symbol] (baby)” and “ [symbol] (infant)”. However, the stem word “ [symbol] (baby)” is not continuous in constituting the word “ [symbol] (infant baby)”. This can be seen in the word “ [symbol] (youth manhood)”, where both “ [symbol] (youth)” and “ [symbol] , (manhood)” can be the stem words.

Meanwhile, a lemma, a word listed in a dictionary, is a different concept from a query. A lemma may be the same as a query, but when the query is inputted in a natural language as such, a lemma is selected from the query and used. A lemma is a different concept from a key word as well. It can be a key word itself and the stem word or its derivative having core meaning of the lemma can be a key word. The present invention described above enlarges utility value of a method and system of information search in all environments and application systems such as wordprocessors, electronic dictionaries, operating systems, Internet search engines, morpheme analysis systems, natural language interfaces and so forth. Providing a stem word or a derivative having core meaning of a lemma based on a core word dictionary, this invention searches out all information related to a user's query and offers them in order most suitable for the query, thus improving convenience on a user's part.

### BRIEF DESCRIPTION OF DRAWINGS

The above and other objects and features of the present invention will become apparent from the following description of the preferred embodiments given in conjunction with the accompanying drawings, in which:

FIGS. 1A and 1B are diagrams describing the structure of a core word dictionary where core words for lemmas are listed in accordance with an embodiment of the present invention;

FIGS. 1C and 1D are diagrams illustrating the structure of a core word dictionary where core words for lemmas are listed in accordance with another embodiment of the present invention;

FIG. 1E is a diagram showing the structure of a core word dictionary where core words for lemmas are listed in accordance with still another embodiment of the present invention;

FIG. 2 is a diagram of an information retrieval system based on the core word dictionary in accordance with an embodiment of the present invention;

FIG. 3 is a flow chart showing a method of extracting core word from a lemma based on the core word dictionary and a method of information searching based thereon in accordance with an embodiment of the present invention; and

FIG. 4 is a flow chart showing a method of extracting core word from a lemma based on the core word dictionary and a method of searching information based thereon in accordance with another embodiment of the present invention.

### BEST MODE FOR CARRYING OUT THE INVENTION

Other objects and aspects of the invention will become apparent from the following description of the embodiments with reference to the accompanying drawings, which is set forth hereinafter.

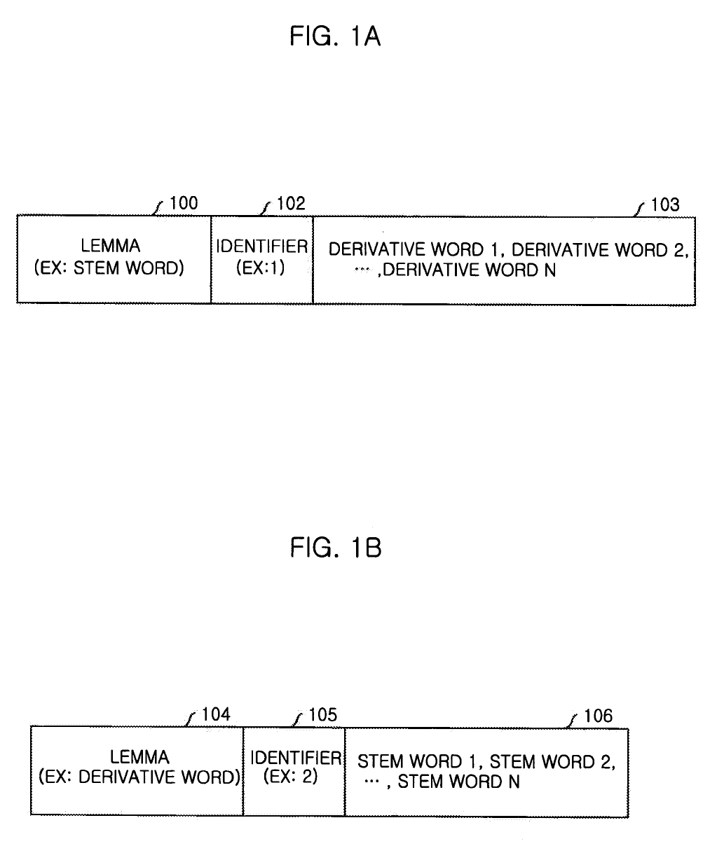

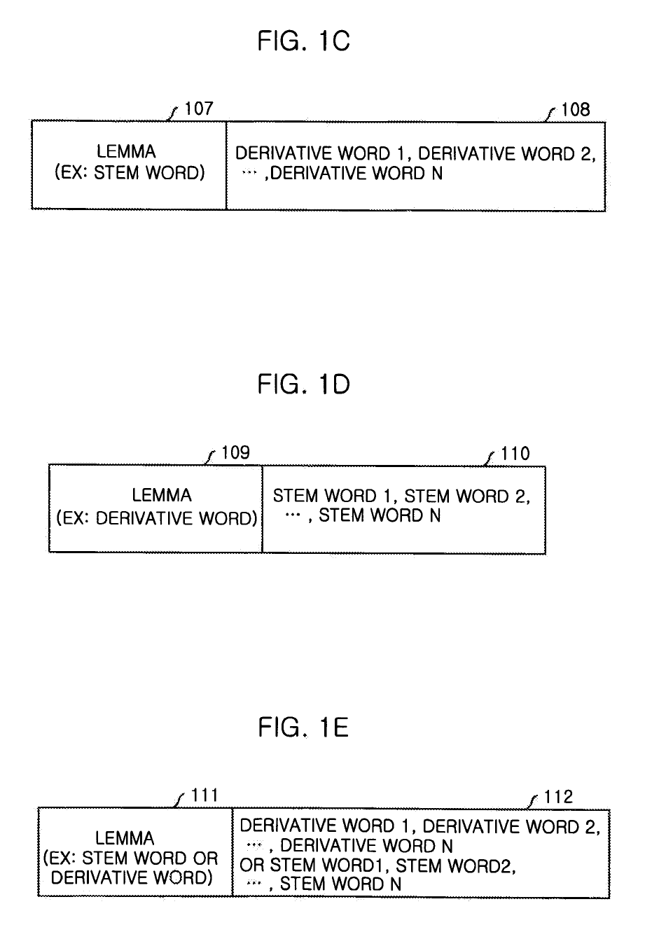

FIGS. 1A and 1B are diagrams describing the structure of a core word dictionary in which the key word for each lemma is listed in accordance with an embodiment of the present invention.

In FIGS. 1A and 1B, the core word dictionary of the present invention is constructed as a database, and the kind of each lemma is marked with identifiers.

As seen in the figures, stem words or derivative words 101, 104 are inserted in the position for a lemma, which is the first field, while identifiers 102, 105 for identifying if the lemma is a stem word or an derivative are inserted in the second field. In the third field, if the lemma is a stem word, derivative words for it are inserted; otherwise, if the lemma is a derivative, the stem words 103, 106 having core meaning of the lemma are inserted.

That is, as shown in FIG. 1A, if the lemma is a stem word, the stem word 101 is inserted in the position for a lemma of the first field, and the identifier (example: 1) 102 identifying the lemma as a stem word is inserted in the second field, while the derivative 103 having core meaning of the stem word is inserted in the third field as a core word.

As seen in FIG. 1B, in case the lemma is an derivative word, the derivative 104 is inserted in the position for a lemma, and the identifier (example: 2) 105 identifying the lemma as a derivative is inserted in the second field, while the stem word 106 having core meaning of the derivative is inserted in the third field as a core word of the lemma.

For example, when the core word is “politic” and its derivative words are “politician,” “political,” “politically,” an embodiment formed as a database as mentioned before is as follows:

| | | |
|---|---|---|
| LEMMA | Identifier | CORE WORD |

| | | | | |
|---|---|---|---|---|
| politic | 1 | politician | statesman | Political |
| politician | 2 | politic | | |
| statesman | 2 | politic | | |
| political | 2 | politic | | |

In the above embodiment for the structure of the core word dictionary, the method of constructing a database of a core word dictionary is illustrated. However, it's possible to cooperate a first database that includes derivatives having core meaning of the stem word when a lemma is a stem word with a second database that includes stem words having core meaning of the derivative when a lemma is a derivative. But in this case, an identifier field needs not be inserted separately because the two databases are distinctive to each other. This is shown in FIGS. 1C and 1D.

FIGS. 1C and 1D are diagrams illustrating the structure of a core word dictionary in which core words for lemmas are listed in accordance with another embodiment of the present invention.

FIG. 1C is a structural figure of a first database when a lemma is a stem word, in which the stem word 107 is inserted in the first field, a field for a lemma, and a derivative 108 having core meaning of the stem word is inserted in the second field.

FIG. 1D is a structural figure of a second database when a lemma is a derivative, in which the derivative 109 is inserted in the first field, a field for a lemma, and the stem word 110 having core meaning of the derivative is inserted in the second field.

For example, when the stem word is “politic” and its derivatives are “politician,” “political” and “politically,” the structure of a first database of an embodiment formed of two databases as described above is as follows:

| LEMMA | CORE WORD |
|---|---|
| politic | Politician, political, politically |

And the structure of the second database is as shown below.

| LEMMA | CORE WORD |
|---|---|
| politician | politic |
| political | politic |
| politically | politic |

Unlike the above embodiments, it's also possible to construct one single database without using any identifier. But the derivatives having core meaning of the lemma should be listed, which will be described in FIG. 1E.

FIG. 1E is a diagram showing the structure of the core word dictionary the core words for lemmas are listed in accordance with yet another embodiment of the present invention.

In FIG. 1E showing a structure of an embodiment formed of a single database with no identifier, its first field 111, the field for a core word, is occupied by either stem word or derivative. And if the lemma is a stem word, the second field is inserted with a derivative having core meaning of the lemma. Otherwise, if the lemma is a derivative, its stem word and derivatives having core meaning of the lemma are inserted to the second field 112.

For example, when a stem word is “politic” and its derivatives are “politician,” “political” and “politically,” the above embodiment formed of a single database with no identifier are shown as follows:

| | |
|---|---|
| LEMMA | CORE WORD |

| | | | |
|---|---|---|---|
| politic | politician | politician | Political |
| statesman | politic | politician | Political |
| politician | politic | statesman | Political |
| political | politic | politician | politician |

A core word dictionary can be constructed in various ways as described above examples. The fundamental reason for constructing such a core word dictionary is to find out words, stem words or derivatives, that have core meaning of lemmas.

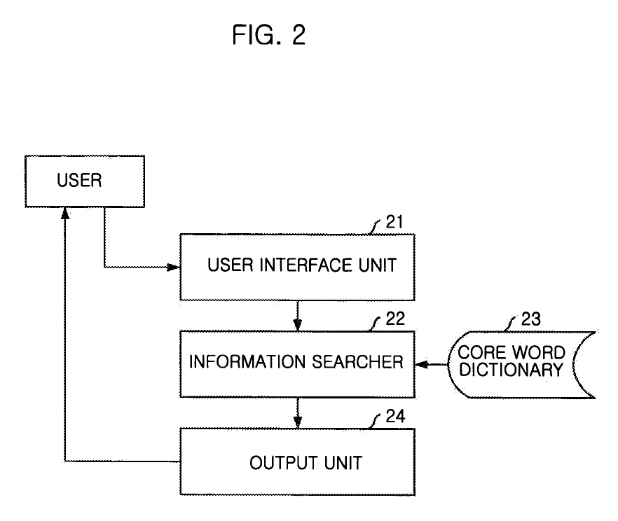

FIG. 2 is a diagram of an information retrieval system based on the core word dictionary in accordance with an embodiment of the present invention.

As shown in FIG. 2, the information retrieval system of the present invention either stores lemmas and stem words or derivatives having core meaning of the lemmas as stem words, or comprises an identifier for identifying a lemma and if the lemma is a stem word or derivative, a core word dictionary 23 for storing stem words or derivatives as core words, a user interface unit 21 for at least one query being inputted from a user, an information searcher 22 for setting a query from a user as a lemma for accessing to the core word dictionary 23, extracting words, stem words or derivatives, having core meaning of the lemma and conducting information search with the lemma set above or the extracted stem words or derivative as a key word for searching after expanding the lemma, and an output unit 24 for showing the search result in a form the user wants. Here, the procedure of setting a lemma out of query words from a user will not be further explained as it is using a method of obtaining one or more lemmas by processing the query with a morpheme analyzer well known to anyone skilled in the art.

The structure and operation of the information retrieval system will be described more in detail hereinafter.

The information retrieval system of the present invention either stores lemmas and stem words or derivatives having core meaning of the lemmas as core words, or comprises an identifier for identifying a lemma and if the lemma is a stem word or derivative, a core word dictionary 23 for storing stem words or derivatives as core words, a user interface unit 21 for at least one query being inputted from a user, an information searcher 22 for setting a query from a user as a lemma for accessing to the core word dictionary 23, extracting words, stem words or derivatives, having core meaning of the lemma and conducting search with the lemma set above or extracted stem words or derivative as a key word for searching after expanding the lemma, and an result output unit 24 which puts different weights on the key words before expansion (lemmas) and key words after expansion (stem words or derivatives)—that is, putting different weights on the results acquired by using a lemma as a key word and ones by using a stem word or derivative as a key word—and outputs search results in the priority order by the weight.

In case that the core word dictionary 23 is formed of one single database and uses identifiers as seen in FIGS. 1A and 1B, the expansion procedures at the information searcher 22 are as described below. The lemma is inquired to the core word dictionary 23 and the identifier is checked. If the lemma is a stem word, the lemma is expanded by a derivative having core meaning of the lemma. If the lemma is a derivative, a stem word having core meaning of the lemma is extracted and the extracted stem word as a lemma is inquired again to the core word dictionary 23, and the lemma is expanded by the extracted derivative. Here, the extracted stem word can be used in the expansion.

In case the core word dictionary 23 is formed of two databases with no identifier as shown in FIGS. 1C and 1D, the expansion procedures at the information searcher 22 are as described below. The lemma is inquired to a first database and checked if the corresponding lemma is a stem word. If it is a stem word, the lemma is expanded by the derivative having core meaning of the lemma. Otherwise, it is inquired to the second database and the stem word having core meaning of the lemma is extracted. Then, the extracted stem word, which will be used as a lemma, is inquired to the first database and expanded by the extracted derivative.

In the two methods of expansion, you can us a stem word as a query or not. In case of using a stem word as a query, the priority order for output may be the result searched with a lemma as a query coming first, followed by results searched with a stem word as a query and then other results searched with a derivative being outputted without any priority order. However, this is nothing but an example. Actually, it's also possible to output results searched with a derivative word prior to ones searched with a stem word, or to output results searched with derivatives in order as such as you want. When a query is not a stem word, the output order of priority may have the result searched with a lemma as a query first, and the rest of them being outputted out of order. Also the order of priority can be defined in various ways here, e.g., outputting results searched out with derivatives according to what a user wants.

In case the core word dictionary 23 is formed of one database without any identifier, the expansion at the information searcher 22 process as follows. The lemma is inquired to the core word dictionary 23 and expanded by using a stem word or derivative having core meaning of the corresponding lemma. In this case, the core word dictionary 23 can be constructed putting weights on the stem word or derivative in advance while being constructed. Thus, all you need to do is output the results searched with corresponding stem word or derivative in a corresponding order.

Meanwhile, the information retrieval system described above needs the steps of collecting data in advance and indexing so that the data are treated and stored in forms easy to figure out what they are about. So, the present invention also adopts the index database as in the concept of the above core word dictionary. For example, in case information of words morphologically related such as politic, politician, political and politically is collected, its lemmas, i.e., politic, politician, political and politically, are stored in the index database as indexes. Therefore, the volume of the index database of the present invention can be reduced remarkably compared with conventional index database indexing partial letter strings as an index. Besides, capable of indexing this invention can yield better search results suitable for the demand from a user. Capable of indexing faithful to the text meaning, it yields search results more proper to the demand of a user, compared to the conventional index databases indexing the root of a word. This indexer can be formed in diverse ways such as being included in or connected to the information searcher 22.

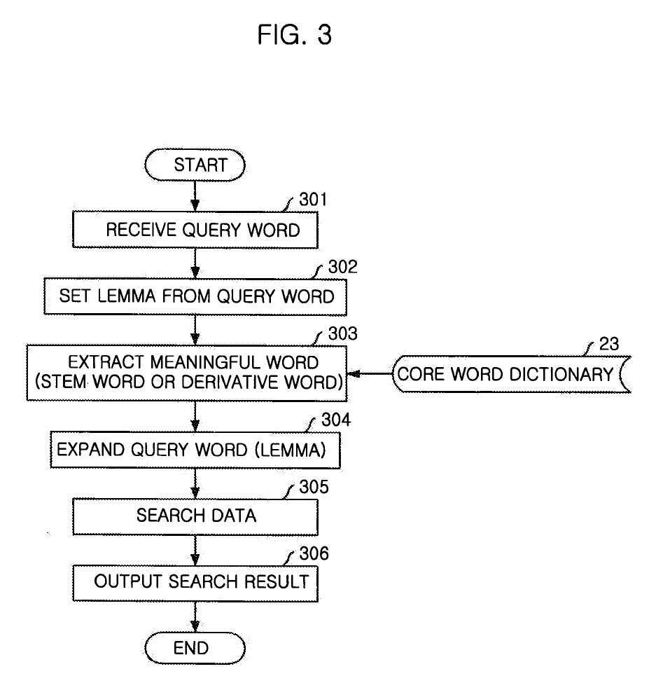

FIG. 3 is a flow chart showing a method of extracting core word from a lemma using a core word dictionary and a method of searching information based thereon in accordance with an embodiment of the present invention.

As illustrated in FIG. 3, at step 301, a query for data searching is inputted to the user interface unit 21 from a user and, at step 302, a lemma for accessing to the core word dictionary 23 is set from the one or more query words consisting the question. Then, at step 303, accessing to the core word dictionary 23 with the lemma set above, words having core meaning of the lemma, stem word or derivative, is extracted. At step 304, the lemma is expanded by the extracted core words, stem word or derivative. At step 305, taking the set lemma, the extracted core word or derivative as a searching key word, the data searching is conducted. At step 306, the search result is outputted and terminated. If there are a plurality of lemmas, a procedure (not shown in drawings) of a user selecting which of the lemmas to use as a key word may be inserted after conducting the lemma expansion procedure at the step 304. This can be applied to the system described above.

The above method will be explained more in detail hereinafter.

First, a core word dictionary formed of one or more databases is constructed by setting as a core word a lemma and a stem word or derivative having core meaning of the lemma. A core word dictionary formed of a single database is constructed by setting as a core word a lemma, an identifier for identifying if the lemma is a stem word or a derivative, and a stem word or a derivative having core meaning of the lemma. A core word dictionary formed of a single database is constructed by setting as a core word a lemma and a stem word or a derivative having core meaning of the lemma.

Then, at step 301, the user interface unit 21 is inputted with one or more query words from a user and transmits it to the information searcher 22. At step 302, receiving the query words, the information searcher 22 sets lemmas to inquire to the core word dictionary 23. The lemmas set above is inquired to the core word dictionary 23 and the words, at step 303, stem word or derivative, having core meaning of the lemmas are extracted. At step 304, the lemmas are expanded by the extracted core words, stem word or derivative, and the information related to the above set lemmas or extracted stem word or derivative, which are taken as search key words, at step 305. After that, the result output unit 24 levies different weights on the key words (lemmas) before expansion and the key words (stem words or derivatives) after expansion, that is, putting weights differently on the result searched with the lemmas as key words and the one searched with the stem words and derivatives as the key words. And at step 306, the search results are outputted to a user in priority order according to the weights. Meanwhile, in case there are a plurality of lemmas, after the expansion of lemmas, the information searcher 22 may conduct a procedure (not shown in drawings) for a user selecting which of the expanded lemmas to use as a key word.

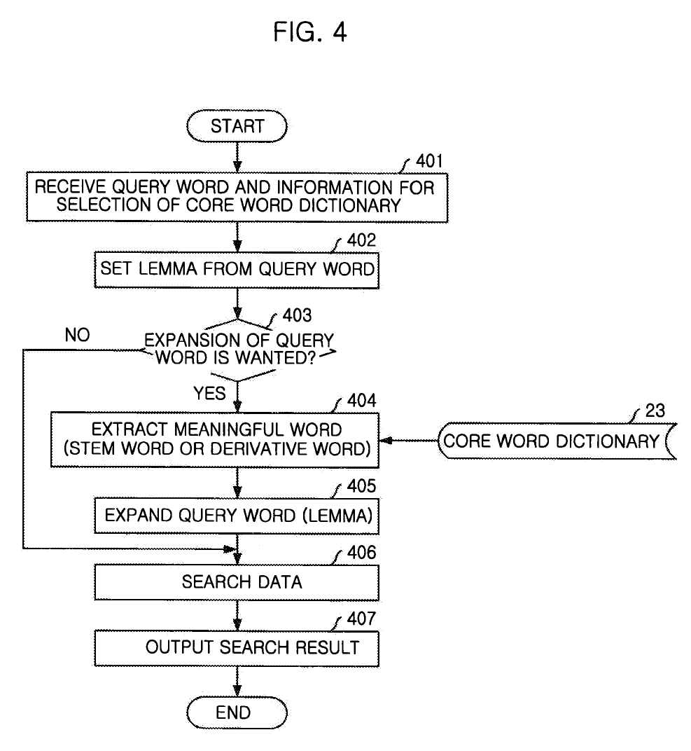

FIG. 4 is a flow chart showing a method of extracting core word from a lemma based on a core word dictionary and a method of searching information based thereon in accordance with another embodiment of the present invention.

First, a core word dictionary formed of one or more databases is constructed by setting as a core word a lemma and a stem word or derivative having core meaning of the lemma. A core word dictionary formed of a single database is constructed by setting as a core word a lemma, an identifier for identifying if the lemma is a stem word or a derivative, and a stem word or a derivative having core meaning of the lemma. A core word dictionary formed of a single database is constructed by setting as a core word a lemma and a stem word or a derivative having core meaning of the lemma.

Then, at step 401, the user interface unit 21 receives selection information on whether to expand the query word from a user based on the core word dictionary together with a query, and transmits it to the information searcher 2. Inputted with the query and the selection information, at step 402, the information searcher 22 sets a lemma to inquire to the core word dictionary 23 according to the query word, and determines if the transmitted selection information is one expanded by using the core word dictionary 23 at step 403.

At step 406, if the expansion based on the core word dictionary 23 is not desired, at step 406, information search is conducted by using the current lemma that has been set already. The result is outputted at step 407 and the logic flow terminates.

If the expansion based on the core word dictionary 23 is desired, at step 404, the lemma set above is inquired to the core word dictionary 23 and words, stem word or derivative, having core meaning of the lemma is extracted. Then at step 405, the lemma is expanded by the extracted core word, stem word or derivative, and at step 406, related information is searched with the above set lemma, the extracted stem word or the extracted derivative as a key word. After that, the result output unit 24 puts different weights on the key word before expansion (lemma) and the key word after expansion (stem word or derivative). In other words, different weights are put on the result searched with the lemma as a key word and on the one searched with the stem word or derivative as a key word. Then at step 407, the search results are outputted to the user in the priority order according to weight. In the mean time, in case there are a plurality of lemmas, after the expansion of lemmas at the step 405, the information searcher 22 may conduct a procedure (not shown in drawings) for a user selecting which of the expanded lemmas to use as a key word.

Although drawings have been referred to describe the method of searching data in other embodiments above, the information retrieval system of those embodiments can be realized similar to the information retrieval system illustrated in FIG. 2. All you need to do to do this is just equip an information checker for determining if the selection information from a user is one expanded by using a core word dictionary at one end of the user interface unit 21. The information checker can be embodied in the information searcher 22. Its overall operation is described in FIG. 4.

As mentioned before, the core word dictionary of the present invention includes the concepts of thesauruses, words with similar meaning, the same words spelled differently and natural language processing. For instance, in case a query is typed in a natural language or else, a lemma is selected first from the query and then the core word dictionary may be used.

As described above, the method of the present invention is programmable and can be recorded in a computer-readable recording medium, e.g., CD ROMs, RAMs, ROMs, floppy disks, hard disks, optical-magnetic disks, etc.

The present invention as described above uses a stem word or derivative having core meaning of a lemma as a core word of the lemma, thus enlarging the utility value of search methods and systems in all environments and application systems such as a word processor, electronic dictionary, operating system, Internet search engine, morpheme analysis system and natural language interface. This invention also can leave out search results not related to the user's query, and searching everything related to his or her query, it provides the result in the priority order most suitable for the query, thereby increasing the confidence of information search as well as improving convenience of the user.

To be more precisely with an example, in case of the present invention applied, the core word dictionary includes information that “back” is a stem word as it is and the stem word of the word “backbone” is “bone.” Using this information, the word “backbone” is not searched at the user's query of “back.” And at the query of “backbone,” information related to its stem word “bone” can be searched and provided.

Also, the volume of an index database can be reduced considerably compared to conventional methods.

While the present invention has been described with respect to certain preferred embodiments, it will be apparent to those skilled in the art that various changes and modifications may be made without departing from the scope of the invention as defined in the following claims.

What is claimed is:

1. A system for processing a search query, the system comprising:
a database comprising a plurality of entries with a first field and a second field, wherein the first field of one of the plurality of entries comprises a term or phrase, and the second field of the same entry comprises a derivative or stem word of the term or phrase;
a user interface module configured to receive a search query comprising one or more words; and
a processing module that is:
configured to select a first term from the search query,
configured to locate the selected first term in the first field of the database entries, and
configured to retrieve a first derivative or stem word of the selected first term in the second field of the located first term entry.

2. The system of claim 1, further comprising a search engine configured to conduct a first search using the first term and formulate a first search result as part of a response to the search query.

3. The system of claim 2, wherein the search engine is further configured to conduct a second search using the first derivative or stem word and formulate a second search result as part of the response to the search query.

4. The system of claim 3, further comprising an output module configured to send the first and second search results so as to be presented separately.

5. The system of claim 4, wherein the output module is configured to formulate an order of displaying the first and second search results based on a weight applied to the first and second terms.

6. The system of claim 1, wherein the processing module is further configured to locate a second term in the first field of the database entries, wherein the second term is the derivative or stem word of the first term, wherein the processing module is further configured to retrieve a second derivative or stem word of the second term in the second field of the located second term entry.

7. The system of claim 6, further comprising a search engine configured to conduct a search using the second derivative or stem word and formulate a search result as part of a response to the search query.

8. The system of claim 1, further comprising another database comprising a plurality of entries with a first field and a second field, wherein the processing module is further configured to locate the derivative or stem word of the first term in the first field of the other database, wherein the processing module is further configured to retrieve data of the second field of the located the derivative or stem word entry.

9. The system of claim 1, wherein the plurality of entries comprises a third field comprising information indicating that the second field comprises either a derivative word or a stem word of the term or phrase of the first field.

10. The system of claim 1, wherein the stem word is a continuous string of letters of the selected term.

11. The system of claim 1, wherein the stem word comprises a first continuous string of letters of the selected term and a second continuous string of letters, wherein the first and second continuous strings of letters are separated from each other.

12. The system of claim 1, wherein the user interface module is further configured to provide a user with an option to select at least one search using at least one of the first term and the first derivative or stem word of the first term.

13. The system of claim 12, wherein the user interface module is further configured to receive a selection from the user to conduct a first search using the first term, a second search using the first derivative or stem word of the first term or both the first and second searches.

14. A system of processing a search query, the system comprising:
a database comprising a plurality of entries with a first field and a second field, wherein the first field of one of the plurality of entries comprises a term or phrase, and the second field of the same entry comprises a derivative or stem word of the term or phrase;
means for receiving a search query from a user, the search query comprising one or more words;
means for selecting a first term from the search query;
means for locating the first term in the first field of the plurality of entries; and
means for retrieving a first derivative or stem word of the first term in the second field of the located first entry.

15. The system of claim 14, further comprising search means for conducting a first search using the first term.

16. The system of claim 15, wherein the search means is configured to further conduct a second search using the first derivative or stem word.

17. The system of claim 16, further comprising output means for sending the result of the first search and the result of the second search separately.

18. The system of claim 16, wherein the output means is further configured to formulate an order of displaying the first and second search results based on a weight applied to the first and second terms.

19. The system of claim 14, wherein the locating means is further configured to locate a second term in the first field of the plurality of entries, wherein the second term is the derivative or stem word of the first term, wherein the retrieving means is further configured to retrieve a second derivative or stem word of the second term in the second field of the further located second entry.

20. The system of claim 19, further comprising search means for conducting a search using the second derivative or stem word.

21. The system of claim 14, further comprising another database comprising a plurality of entries with a first field and a second field, wherein the mean for locating is further configured to locate the derivative or stem word of the first term in the first field of the other database, wherein the means for retrieving is further configured to locate data of the second field of the further located entry.

22. The system of claim 14, wherein the plurality of entries comprises a third field comprising information indicating that the second field comprises either a derivative word or a stem word of the term of phrase of the first field.
